(19) United States
(12) Patent Application Publication
(10) Pub. No.: US 2007/0108031 A1
(43) Pub. Date: May 17, 2007

(54) Switch pin for SMD manufacturing processes

(75) Inventor: Tsui-Jung Su, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/272,692

(22) Filed: Nov. 15, 2005

(51) Int. Cl. H01H 5/30

(52) U.S. Cl. 200/448

(57) ABSTRACT

A switch pin for SMD manufacturing processes to be mounted onto a circuit board includes a connection end located in a switch and a coupling end extended from the connection end and exposed outside the switch. The coupling end has a horizontal portion and a bend portion bending from the horizontal end towards the switch. Hence the signal pin and the circuit board can form a greater electric connection area to enhance electric effect of the switch. The bend portion also can prevent interference of other electronic elements installed on the circuit board.

### FIELD OF THE INVENTION

The present invention relates to a switch pin for SMD manufacturing processes and particularly to a signal pin which has a coupling end exposed outside a switch that includes a horizontal portion and a bend portion bending from the horizontal portion towards the switch to increase electric connection area of the signal pin and a circuit board to achieve a desired electric effect of the switch and prevent interfering with other electronic elements on the circuit board.

### BACKGROUND OF THE INVENTION

With the advance of technology, the size of electronic devices (such as mouse) becomes smaller. The electronic elements used on those smaller electronic devices also have to be miniaturized. A great portion of these electronic elements are switches. Refer to FIG. 1 for a conventional switch. In order to meet the requirements of SMD (Surface Mount Device) manufacturing processes, the signal pins of the switch are exposed outside the switch. The exposed portion is straight and horizontal to the switch and a circuit board. Such a structure often creates fabrication problems or results in poorer quality. More details are elaborated as follow:
1. Due to shrinking of the electronic device, the interior space is limited. The space available to accommodate the circuit board also decreases. Hence the space occupied by the exposed signal pins is limited. As shown in FIG. 1, the extended and exposed portion of the signal pin takes too much space and affects installation of other electronic elements. This creates configuration design problem of the electronic elements.
2. To remedy the aforesaid shortcoming, some producers have shortened the length of the exposed portion or even keep the exposed portion on the bottom of the switch. While such an approach can reduce the occupied space, it also reduces the soldering paste attached thereon during the SMD processes and results in not secure bonding and not desirable electric effect of the switch. Moreover, when the electronic device is under functional test, if defects of the switch occur and replacement is needed, unsoldering for replacement is difficult because of the exposed portion is hidden on the bottom of the switch.

### SUMMARY OF THE INVENTION

Therefore the primary object of the present invention is to solve the aforesaid disadvantages. The invention provides a signal pin which includes a connection end located inside a switch and a coupling end extended outside the switch from the connection end. The coupling end has a horizontal portion and a bend portion bending towards the switch from the horizontal end. Thus electric connection area between the signal pin and a circuit board can increase to achieve the desired electric effect. Moreover, bending of the bend portion toward the switch can prevent interference on other electronic elements mounted onto the circuit board.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional switch.

FIG. 2 is a perspective view of the present invention.

FIG. 3 is an exploded view of the signal pin of the present invention.

FIG. 4 is a bottom view of a signal pin configuration of the present invention.

FIG. 5 is a bottom view of another signal pin configuration of the present invention.

FIGS. 6, 6A and 6B are schematic views of the invention used in SMD manufacturing processes.

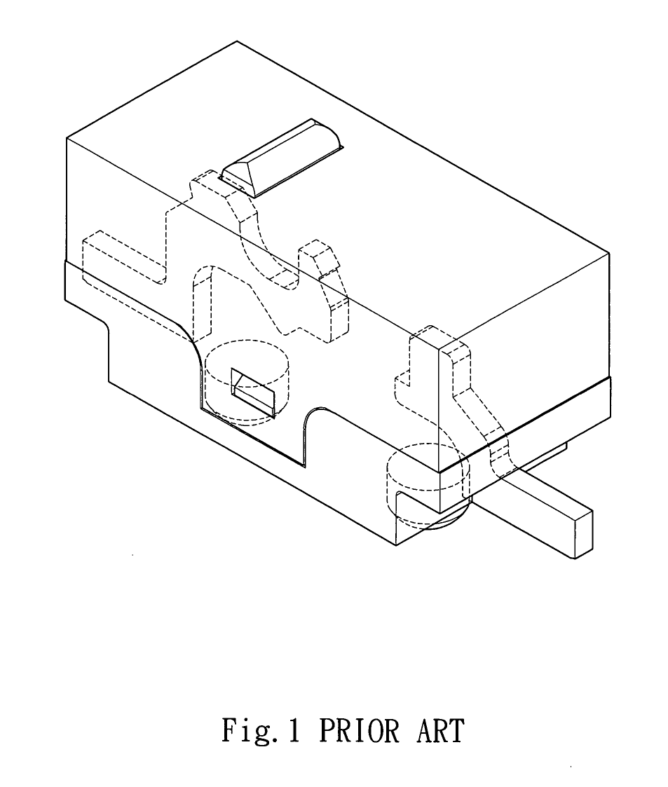

### DETAILED DESCRIPTION OF THE PREFERRED EMBODIMENTS

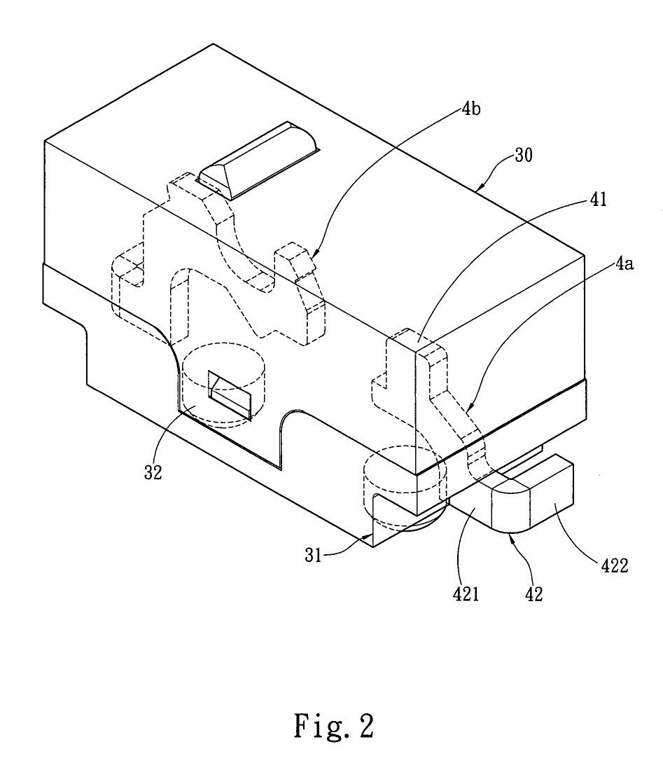

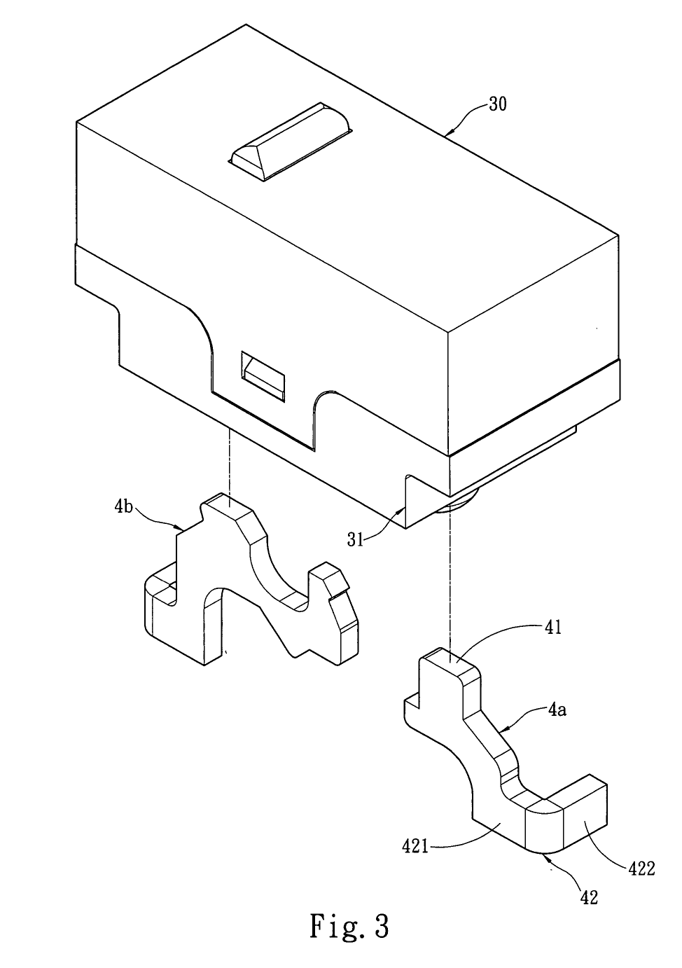

Please referring to FIGS. 2 and 3, the present invention aims to provide pins of a switch 30 to be used in SMD manufacturing processes. The switch 30 has signal pins 4a and 4b extended to be mounted onto a circuit board 10 through the SMD manufacturing processes. The techniques of generating signals by depressing the switch 30 and the SMD manufacturing processes are known in the art, and form no part of the present invention, thus the following discussion is confined to contents related only to the present invention.

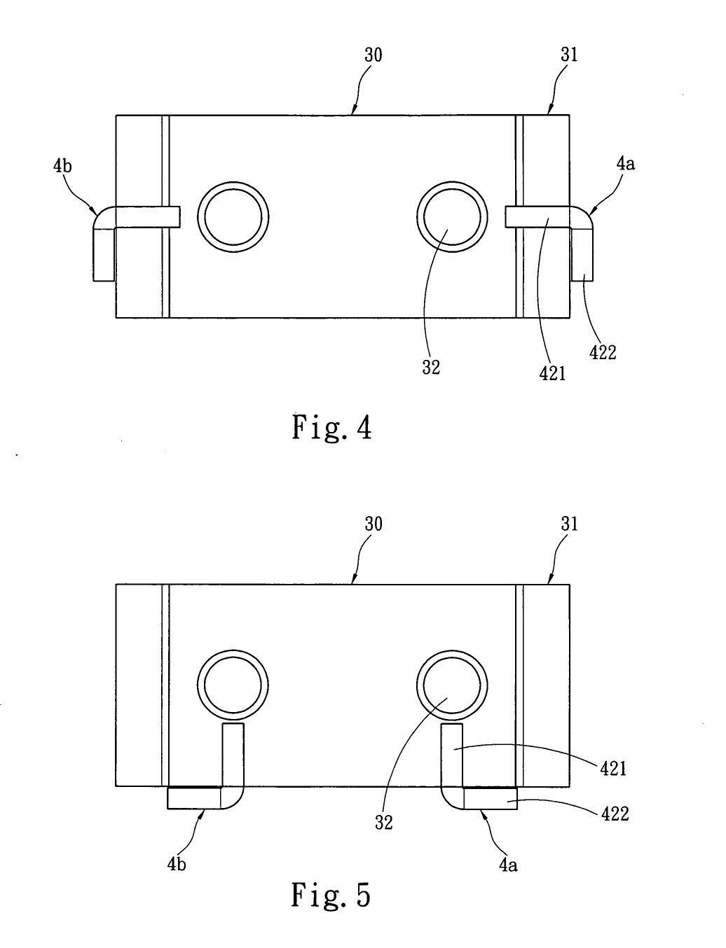

The signal pins 4a and 4b have respectively a connection end 41 located inside the switch 30 and a coupling end 42 extended from the connection end 41 and exposed outside the switch 30. The coupling end 42 has a horizontal portion 421 and a bend portion 422 bending towards the switch 30. The horizontal portion 421 is located beneath the switch 30. The bend portion 422 is located on one side of the switch 30 (also referring to FIGS. 4 and 5). To facilitate unsoldering and replacement in the event of defects occurred to the switch 30 during test of the switch 30 on the installed electronic device, the switch 30 has an indentation 31 corresponding to the coupling end 42 of the signal pins 4a and 4b.

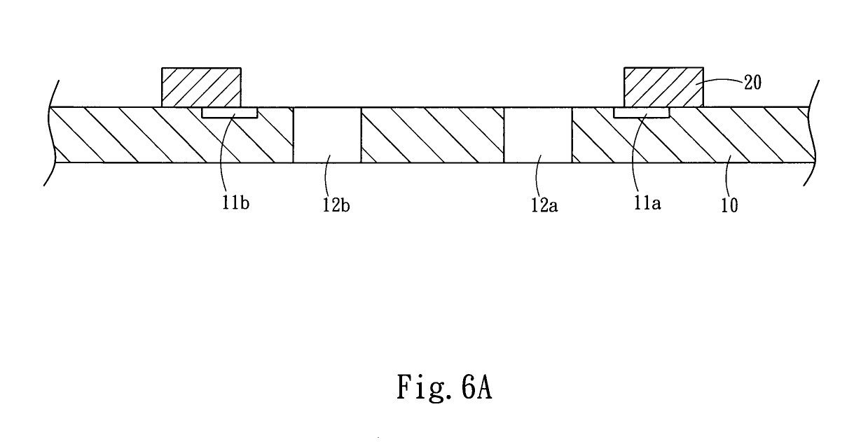

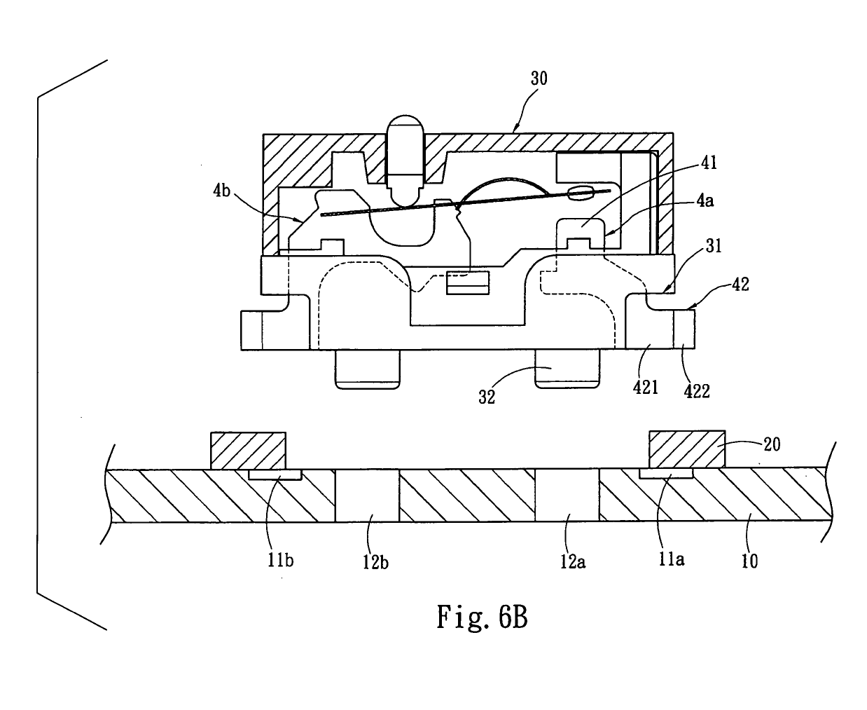

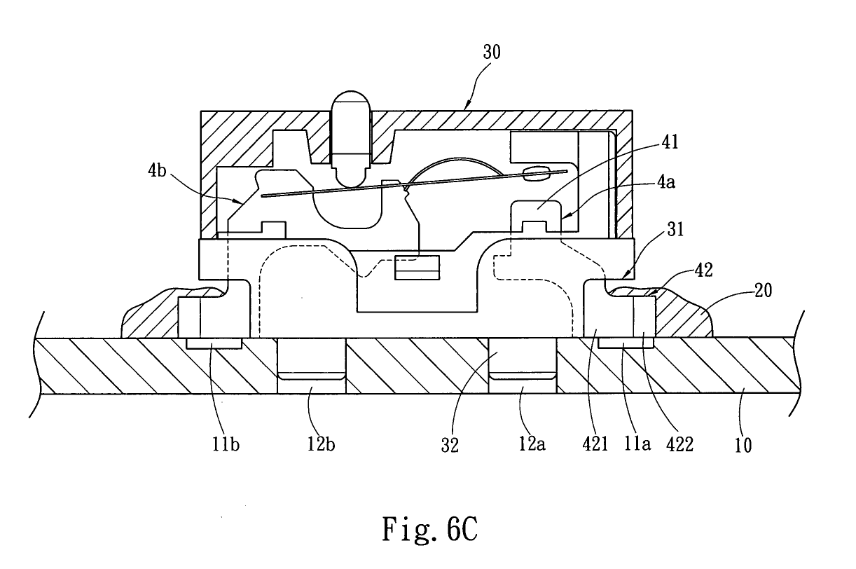

Refer to FIG. 6 for the invention adopted for use in the SMD manufacturing processes. First, prior to mounting the switch 30 onto the circuit board 10, dispense soldering pastes 20 (usually soldering tin) onto the circuit board 10 between the signal pins 4a and 4b and corresponding contacts 11a and 11b of the circuit board 10. Referring to FIG. 6A, mount the switch 30 onto the circuit board 10 with the signal pins 4a and 4b bonding to the soldering pastes 20. In this embodiment, to facilitate a secure soldering of the switch 30 during the SMD manufacturing processes, the switch 30 has bosses 32 on the bottom mating anchor holes 12a and 12b formed on the circuit board 10. Referring to FIG. 6B, while the switch 30 is fused at a high temperature on the circuit board 10 during the SMD manufacturing processes, the molten soldering pastes 20 bond the horizontal portion 421 and bend portion 422 of the signal pins 4a and 4b. A portion of the molten soldering pastes 20 even covers the upper side of the bend portion 422 (depending on the molten quantity of the soldering pastes 20). As shown in FIG. 6B, after the switch 30 is bonded to the circuit board 10, the soldering pastes 20, in addition to bonding the horizontal portion 421 and bend portion 422, also covers the bend portion 422. Thus a more secured bonding and enhanced electric effect can be achieved. Moreover, the bend portion 422 does not interfere installation of other electronic elements as the conventional switch does.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A switch pin for SMD manufacturing processes that has signal pins extended from a switch to be mounted onto a circuit board through the SMD processes, comprising:
a connection end located in the switch and a coupling end extended from the connection end and exposed outside the switch, the coupling end having a horizontal portion and a bend portion bending towards the switch from the horizontal end.

2. The switch pin of claim 1, wherein the horizontal portion is located beneath the switch and the bend portion is located on one side of the switch.

3. The switch pin of claim 1, wherein the switch has an indentation corresponding to the coupling end.
